(19) United States
(12) Patent Application Publication
(10) Pub. No.: US 2009/0214705 A1
(43) Pub. Date: Aug. 27, 2009

(54) METHOD FOR MODIFYING HYGIENIC, PHYSICO-CHEMICAL AND SENSORY PROPERTIES OF CHEESE BY CONTROLLING THE REDOX POTENTIAL

(76) Inventors: Henry J. Ledon, Versailles (FR); Dominique Ibarra, Gif-Sur-Yvette (FR)

Correspondence Address: AIR LIQUIDE;Intellectual Property, 2700 POST OAK BOULEVARD, SUITE 1800, HOUSTON, TX, 77056, US

(21) Appl. No.: 11/910,718

(22) PCT Filed: Mar. 30, 2006
(86) PCT No.: PCT/FR2006/050275

§ 371 Date: Jun. 9, 2008

(30) Foreign Application Priority Data
Apr. 6, 2005 (FR) 0503440

(51) Int. Cl. A23C 19/14; A23C 19/05; A23C 19/06

(52) U.S. Cl. 426/40

(57) ABSTRACT

The invention concerns a method for making ripened cheese having enhanced organoleptic properties, which consists, during one of the steps of the manufacturing method, in inoculating a dairy mixture with one or more lactic acid bacterial strains, and in a step of ripening the manufactured cheese. Said method is characterized in that it includes one or each of the following steps: prior to the inoculating step, processing the dairy mixture with a process gas comprising a neutral gas or a reducing gas or a mixture thereof to obtain a desired redox potential value Eh which is less than the value obtained when the dairy mixture is at equilibrium with air; all or part of the ripening step is carried out under a reducing ripening atmosphere.

The present invention relates to the field of the manufacturing of ripened cheeses, and in particular to the step for ripening cheeses, and endeavors to provide a novel method for manufacturing and ripening cheeses having novel sensory and physicochemical properties and having a reduced risk in terms of food safety.

Oxidoreduction reactions are essential steps in the processes of cell anabolism and catabolism, for which the direction of the exchanges is directed by the redox potential (Eh). The Eh is a fermentation state parameter; variation thereof modifies the physico-chemical environment of microorganisms. The metabolic activities and the physiology of microorganisms are determined by the intracellular pH (pHᵢₙ), which will condition the activity of the enzymes and the accessibility of certain substrates and cofactors in metabolic reactions. The pHᵢₙ depends on the extra-cellular pH (pHₑₓ) and on the ability of the micro-organism to maintain a certain cell homeostasis. The difference between the pHᵢₙ and pHₑₓ will also modify the proton motive force ΔμH⁺, {ΔμH⁺=Δψ (electrical potential gradient)−ZΔpH (pH gradient)}, which is in particular involved in exchanges of the microbial cell with the outside. The parameters Eh and pHᵢₙ are intimately linked; thus, the energy found in high-potential compounds such as adenosine triphosphate (ATP) and generated by substrate catabolism may be used by the cell in order to maintain its pHᵢₙ (and therefore its ΔpH) by virtue of membrane ATPases.

In nutritional media, the redox potential, or Eh, is comparable to the pH due to the fact that it expresses an equilibrium between the oxidizing compounds and the reducing compounds of a composition which may be complex, for example milk. Many studies show that the Eh intervenes at several levels in the quality of fermented dairy products (see, for example, the studies by Law et al., published in 1976 in Journal of Dairy Research. 43: 301-311; the studies by Kristoffersen et al., published in 1985, in Milchwissenschfat. 40: 197-199; or else by Dave et al., published in 1997 in International Dairy Journal: 31-41). If one considers that an optimum Eh exists for the development of the flora, the initial redox properties of milk become an important technological factor to be taken into account in the manufacturing of these products. Thus, rearing factors, such as the diet, modify the initial redox characteristics of milk. However, for industrial cheese productions, the specifications of which remain open, it is possible to imagine more effective means of modifying and controlling the initial Eh of the milk, thus acting on the acidifying and reducing properties of the leaven strains.

The Eh is still used very little as a parameter for action and control during the manufacturing of food products. It is a physicochemical parameter which, by virtue of its nature, can be measured in all media, provided that the latter contain at least one molecule which can change from an oxidized state to a reduced state, and vice versa. For this reason, its effect can be seen on all cell functions. Its action has been shown on various types of bacterial strains: the addition of chemical reducing agents to culture media has made it possible to significantly modify growth and metabolic fluxes in Corynebacterium glutamicum, Clostridlum acetobutylicum, Sporidiobolus ruinenii and Escherichia coli (see, for example, the studies by Kwong et al., published in 1992 in Biotechnology and Bioengineering. 40: 851-857); a decrease in the value of the Eh (more reducing medium) which has been fixed by gases has made it possible to modify the metabolic fluxes in Saccharomyces cerevisiae with an increase in the glycerol/ethanol ratio and the accumulation of storage sugars with an increase in the survival of yeasts during storage (see FR-2.811.331 in the applicant's name).

In the industrial medium, the role of the Eh is already indirectly taken into account through the dissolved oxygen, the inhibitory effect of which on lactic acid bacteria has been well established. This effect is due to their inability to synthesize cytochromes and enzymes with a heme nucleus.

It is also possible, by acting on the Eh, to modify the survival of probiotic ferments, and the metabolic fluxes, the production and/or the stability of flavoring molecules. All these results have been obtained subsequent to a modification of the Eh by the microorganisms themselves, by redox molecules or by thermal treatment.

Certain lactic acid bacteria are known to possess reducing properties highly expressed in milk, thus modifying the redox properties of the medium. The impact of these modifications is yet to be studied in cheese. However, former studies (such as those by Kristoffersen et al., published in 1964 in Journal of Dairy Science. 47: 743-747; or those by Green et al., published in 1982 in Journal of Dairy Research. 49: 737-748) have shown that, in Cheddar cheeses, a negative Eh can induce sensory qualities which are more stable and better appreciated.

One of the objectives of the present invention is therefore to provide a novel method for manufacturing cheeses having novel sensory and physicochemical properties and having a reduced risk in terms of food safety.

It will be recalled that the manufacturing of a ripened cheese follows extremely complex and varied steps according to the type of cheese envisioned, according to the traditions of each type of cheese and region of origin, etc., reaching several hundred or even thousand different methods, but commonly comprises, at the very least, the following steps;
Preparation of the Manufacturing Milks, Generally by stabilizing them microbiologically (heat treatment such as pasteurization or else physical treatment such as ultrafiltration) and adjusting their physicochemical composition (fats, proteins, etc.).
Coagulation, which can be of three types: rennet coagulation (dominant action of rennet), lactic coagulation (dominant action of ferments) and mixed coagulation.
Draining, which is the step of concentrating the milk elements. The molecular bonds in the coagulum causes a contraction of the network which then expels the lactoserum (water, serum proteins, lactose, soluble minerals, etc.). The draining takes place either by simple gravity, including in an autonomous device of tunnel type, or it is carried out and accelerated by various operations, among which are, for example, centrifugation, cutting, pressing, turning over, heat treatment, etc.
Ripening, an optional step which is not carried out for certain cheeses, such as fromage frais, is a more or less long phase of maturation under defined conditions of temperature and atmospheric humidity, during which chemical, biochemical and enzymatic reactions take place, along with the development of the surface flora. In certain cases, the ripening can take place partly or completely under film. The cheese is then firstly placed in a vacuum under a plastic which is permeable to steam and to specific gases.

As will be seen below, the method for preparing a cheese according to the invention is notable in that one or each of the following steps is carried out:
prior to the inoculating step, the dairy mixture is processed with a processing gas comprising a neutral gas or a reducing gas or a mixture of such gases so as to obtain a desired redox potential Eh value for the dairy mixture which is less than the value obtained when the dairy mixture is in equilibrium with the air;
all or part of the ripening step is carried out under a reducing ripening atmosphere.

The reducing atmosphere is obtained, for example, using a reducing gas such as hydrogen, or else a mixture of a compound which has a high saturating vapor pressure at ambient temperature (such as nitrogen, argon, rare gases, helium, carbon dioxide, nitrous oxide, methane, ethane, propane, cyclopropane, butanes, short-chain haloalkanes, etc.) or a mixture of such gases, and of a reducing gas such as hydrogen.

According to the present invention, preference will, however, be given to gases and mixtures of gases chosen from the gases currently authorized, according to most of the regulations in force, for contact with food products, namely N₂, O₂, CO₂, He, Ar, N₂O, H₂, even though it is known that the regulations are regularly subject to changes.

To this end, the cheese is placed, after its manufacture, in a chamber or else in a bag which is leaktight and which contains such a gas or mixture of gases.

The invention then relates to a method for manufacturing a ripened cheese having enhanced organoleptic properties, which consists, during one of the steps of the manufacturing method, in inoculating a dairy mixture with one or more lactic acid bacterial strains, and in carrying out a step of ripening the manufactured cheese, and which is characterized in that one or each of the following steps is carried out:
prior to the inoculating step, the dairy mixture is processed with a processing gas comprising a neutral gas or a reducing gas or a mixture of such gases so as to obtain a desired redox potential Eh value for the dairy mixture which is less than the value obtained when the dairy mixture is in equilibrium with the air;
all or part of the ripening step is carried out under a reducing ripening atmosphere.

The method according to the invention can also adopt one or more of the following technical characteristics:
said reducing atmosphere is obtained using a reducing gas, or using a mixture of a neutral gas and a reducing gas;
for the purposes of carrying out all or part of the ripening step under a reducing atmosphere, the cheese is placed, after its manufacture, in a chamber or else a packaging which is leaktight and which contains such an atmosphere;
said desired redox potential value is less than +250 mV;
said desired redox potential value is at least 100 mV less than the value obtained when the dairy mixture is in equilibrium with the air;
said desired redox potential value is negative;
the inoculation of the dairy mixture is carried out indirectly due to the fact that one or more successive precultures are carried out beforehand in order to constitute the inoculum which will be used to inoculate the dairy mixture, and the preculture is also processed by processing its growth medium with a pre-processing gas which makes it possible to obtain a redox potential value which is less than the value that would be obtained in the absence of processing;
one or more of said processing or pre-processing gases or ripening atmosphere is hydrogen or a mixture of gases containing hydrogen;
one or more of said processing or pre-processing gases or ripening atmosphere comprises hydrogen and/or nitrogen and a supplementary gas which is acceptable from the point of view of said cheese under consideration;
the supplementary gas is chosen from inert gases, in particular argon and helium, and from oxygen, carbon dioxide and nitrous oxide and mixtures thereof in any proportions, preferably from carbon dioxide and oxygen, and mixtures thereof;
a part of the ripening is carried out conventionally (i.e. according to the practice(s) of the user site under consideration, for example under air, under a gas such as CO₂, etc., under film, or in a chamber, etc.) and a part of the ripening is carried out under said reducing ripening atmosphere (it can be seen that it will then be possible to adopt very varied sequences, such as atmosphere/air, air/atmosphere, air/atmosphere/air, etc., but also the alternating of ripening phases under film/under reducing atmosphere/under film, etc., and thus to obtain, according to the cases envisioned, a better control of the evolution of the product);
the cheese is subsequently conserved under a controlled atmosphere until its best before date (BBD) or its use by date (UBD).

The processing of the dairy mixture (or the pre-processing of the preculture) using a gas or mixture of gases is obtained according to one of the methods well known to those skilled in the art, such as bubbling through the dairy mixture using a sintered glass funnel, a membrane or a porous substance, agitation by means of a hollow-shafted turbine, use of a hydro-injector, falling-film contactor, spraying of the liquid in a chamber under a controlled atmosphere, etc.

One or more gas injection points can be used in the reception and storage tanks for the milk, standardization tanks, enriching tanks, inoculating tanks or intermediate buffering tanks. On-line injections can also be carried out on various parts of pipework of the production plants.

Preferably, the water content will be controlled, or even regulated, in the ripening chamber.

Similarly, preferably, the content of reducing gas used for the ripening, for example hydrogen, will be controlled, or even regulated, in the ripening chamber. It is in fact known that certain cheeses give rise to the production of gaseous species, and in particular of CO₂, and it can therefore be foreseen that, in such a case, the content of reducing gas in the ripening atmosphere will vary over time, hence the advantage of controlling it or even regulating it.

Other characteristics and advantages of the invention will emerge from the examples detailed below.

### EXAMPLE 1

### Influence of the Reducing Conditions on the Manufacturing and the Ripening of a Pasteurized-Milk Uncooked Pressed Cheese

The following protocol was carried out: 4 different manufacturing and ripening modes were tested in order to be able to dissociate the effect of the manufacturing from that of the ripening on the sensory characteristics of the cheeses (see table 1 below). Four repetitions of each of the modes were carried out, i.e., in total, 16 manufactured cheeses, each of 1 kg.

TABLE 1
Description of the 4 modes of manufactured cheeses

| | | MANUFACTURE | |
|---|---|---|---|
| | | Under a reducing | With free |
| | | atmosphere | exchange of air |
| | | (In-isolator | (Cheese dairy |
| | | manufacture) | manufacture) |
| RIPENING | Under a reducing | No. 1 | No. 2 |
| | atmosphere | | |
| | (in leaktight bags) | | |
| | With exchange of air | No. 3 | No. 4 |
| | (in permeable bags) | | |

The reducing atmosphere used was a mixture of 96% nitrogen and 4% hydrogen (expressed by volume). The duration of the ripening carried out was 8 weeks.

The leaven used is a commercial mesophilic leaven consisting of a mixture of strains of Lactococcus lactis subsp. lactis and of Lactococcus lactis subsp. cremoris. It is a leaven marketed under the name MA 011 (conventional acidifying mesophiles from Danisco). This leaven is non-gas-producing for the needs of packaging in sealed sachets during ripening. The leaven was inoculated into the tank in freeze-dried form at the dose of 0.77 U of freeze-dried leaven/100 l of milk, or 0.4-0.5% (V/V) in terms of leaven equivalent with respect to milk. The rennet (700 mg/l of active chymosin, from Danisco) was used at the dose of 0.27 ml/kg of milk.

The cheeses were manufactured either according to a conventional method in the air, without any specific precaution other than the rules of good hygiene practice, in particular of microbiological quality of the ambient air (“cheese dairy manufacture”), or in a hermetic chamber, referred to as an isolator, fitted with a device for sweeping with gas and analyzing the composition of the atmosphere (“in-isolator manufacture”).

During the in-isolator manufacture, the amount of ambient oxygen was maintained below 1%. The manufacturing milk was bubbled for approximately 30 min with the reducing gas in order to reduce the dissolved oxygen content.

The monitoring of the reduction in the tank and in the cheeses at unmolding, and also the monitoring of the dissolved oxygen content, were carried out with continuous recording using Mettler-Toledo electrodes. The redox potential results are expressed as Eh7, i.e. related back to pH=7 (by means of the formulae well known to those skilled in the art, such as the Leistner and Mirna equation, which makes it possible to express the measured Eh of a medium of pH=x, at its value calculated at pH=7). This makes it possible to compare the values with one another regardless of the temperature and the pH at which they were measured.

After bubbling, an average difference in Eh7 of approximately 250 mV, between the two tank milks, is observed at the beginning of manufacturing (“isolator” versus “cheese dairy”).

For the ripening under a reducing atmosphere, the cheeses were enclosed in plastic bags with a high oxygen barrier. These bags were welded shut inside the isolator and then immediately re-welded shut outside in order to reinforce the leaktightness. Two oxygen absorbers were placed in each of these bags, in order to prevent any possible entry of oxygen into the bags during ripening. To ripen the cheeses with a free exchange of air, plastic bags made of simple polyethylene were used in order to prevent substantial drying out of the cheeses ripened with exchange of air, compared with the others.

Table 2 below shows the plan of the microbiological and physicochemical analyses carried out on the milk and the cheeses at the various stages of manufacture.

TABLE 2
Plan of the microbiological and physicochemical analyses carried out
on the milk and the cheeses at the various stages of manufacture.

| Stages of | Carry over | Pasteurized | Standardized | Inoculated | Cheese at end |
|---|---|---|---|---|---|
| manufacture | milk | milk | milk | tank milk | of ripening |
| Physico- | ↓ Proteins (P) | | ↓ Proteins (P) | | ↓ pH |
| chemistry | ↓ Fats (F) | | ↓ Fats (F) | | ↓ Total solids (TS) |
| | | | | | ↓ Fat/solids (F/S) |
| | | | | | ↓ NaCl |
| Micro- | ↓ Viable aerobic | ↓ Viable aerobic | | ↓ Lactococci | ↓ Principally |
| biology | mesophilic flora | mesophilic flora | | | lactococci |
| | or total flora | or total flora | | | ↓ Total coliforms |
| | | ↓ Total coliforms | | | |

### Microbiological Results (Table 3)

The presence of coliforms is in particular observed at the end of ripening, which coliforms are derived either from the manufacturing milk with a considerable development during manufacture and ripening, or from a post-contamination. Irrespective of the origin of these total coliforms, the results show that their development was not influenced by the method of manufacture, but strongly influenced by the method of ripening: 190 000 cfu/g under air compared with 4800 cfu/g under gas, i.e. a factor of 40. The level of lactococci at the end of ripening is significantly increased by ripening under gas: 910 million cfu/g under gas compared with 130 million cfu/g under air, i.e. a factor of 7.

For practical reasons, the flora of certain cheese samples were counted after freezing at −20° C. and thawing of the samples.

TABLE 3
Means of the populations counted at the end of ripening on the cheeses before and after freezing at −20° C.

| | Cheeses “fresh” at | | Cheeses ripened and thawed | | | | | | |
|---|---|---|---|---|---|---|---|---|---|
| Populations in | the end of ripening | | | | | | | Micrococci | Micrococci |
| log cfu/g⁻¹⁰ | Coli. | Lactococci | Coli. | Psychrotr. | FHL | Enterococci | GRAM− | cheese | rind |
| Manuf. | 4.80 | 7.98 | 4.95 | 5.39 | <1000 | 5.84 | 5.33 | 6.14 | 8.79 |
| isolator | | | | | | | | | |
| Manuf. cheese | 5.10 | 8.08 | 4.82 | 4.46 | 6.78 | 4.73 | 5.02 | 5.49 | 8.82 |
| dairy | | | | | | | | | |
| Ripening | 3.68 | 8.96 | <100 | 4.50 | 5.89 | 3.47 | <10 000 | 3.84 | 5.75 |
| under gas | | | | | | | | | |
| Ripening | 5.27 | 8.10 | 5.19 | 5.39 | 6.72 | 5.87 | 5.49 | 6.23 | 9.11 |
| under air | | | | | | | | | |

To the applicant's great surprise, the coliform levels counted at the end of ripening on thawed samples show that the method of ripening influenced the resistance of these microorganisms to freezing.

In fact, for the coliforms, the viable population after freezing represents 3% of the viable population before freezing, for the ripening under gas, whereas it represents 83% for the ripening with exchange of air, which represents a considerable improvement in terms of food safety. The physiological state of the coliforms at the time of freezing, i.e. just as ripening is complete, must have been different. They appear to have been more sensitive to the thermal stress due to the ripening under gas.

The counts performed on the cheeses after thawing should obviously be considered cautiously since they accumulate the effect of the principal “manufacturing method” and “ripening method” factors with the effect of the freezing which can act by interaction with the “manufacturing method” and “ripening method” effects. In fact, the manufacturing method had a significant effect on the level of heterofermentative mesophilic lactobacilli after thawing. It is, however, difficult to say, at this stage, whether it is an effect on the development of this population or an effect on their physiological state at the time of freezing which would generate a difference in resistance of the cells to freezing. This population is acknowledged to be a ripening flora which produces flavor, but may also be responsible for taste defects. The in-isolator manufacturing could therefore slow down the maturation of cheeses or allow a better control thereof. In general, the ripening under a reducing atmosphere appears to block the development of impairing flora, or even of pathogenic flora (GRAM− bacteria).

The development of micrococcal rind flora is also greatly slowed during the ripening under gas: 560 000 cfu/g compared with 1 300 000 000 cfu/g under air. This confers on the cheese ripened under gas a rind which has a “clean” and “healthy” appearance similar to that of a cheese after demolding, unlike a cheese ripened under air, which exhibits an orange-yellow flora over 70 to 100% of its surface area.

### Physicochemical Results

The raw milk was analyzed in terms of fats and proteins so as to be standardized at each manufacture. The statistical analyses showed that the manufacturing method significantly influenced the fat/solids ratio and the amount of moisture in defatted cheese, measured at the end of ripening.

It is also noted that the coagulation time (CT) is on average longer for the in-isolator manufacturing. Now, a longer coagulation time often promises a coagulum which is less firm, generating greater losses of fat in the lactoserum at the time the coagulum is cut. In fact, the fat/solids ratio was greatly influenced by the manufacturing method, in a coherent manner, since cheeses manufactured in-isolator are on average less fatty than cheeses manufactured in the cheese dairy.

The influence of the manufacturing method on the MDC (moisture in defatted cheese: i.e. independently of the fat) shows that the proportion of water in the cheeses at the end of ripening also depends on the manufacturing method. The cheeses with the highest moisture content are those manufactured in the cheese dairy. The exudation of the lactoserum may have been influenced by the manufacturing method or by a difference in cutting. The effect of the manufacturing method on the MDC appears to be modulated by the ripening method. The conditions for packaging the cheeses during ripening were effective since the ripening method did not directly affect the water content of the cheeses. The effect of the manufacturing method on the MDC may have influenced the perception of the judges regarding the texture descriptors, as will be seen below.

The NaCl concentration was influenced by the manufacturing method, although the same brine bath and the same duration were used for all the cheeses. A slightly different physicochemical composition of the curds may have generated differences in texture and therefore differences in absorption of NaCl.

The pH at the end of ripening is found to be statistically very different from one ripening method to another, whereas, this time, the manufacturing method has absolutely no effect. The cheeses ripened with a free exchange of air have a pH which is on average higher (pHav=5.80) than the cheeses ripened under reducing atmosphere (pHav=5.31). The pH of the cheeses ripened with free exchange of air increased during ripening (pHav=5.07 at 20 hours) probably due to the surface and ripening flora which developed thereon, unlike the cheeses ripened under a reducing atmosphere, the surface of which is free of flora.

Table 4 makes it possible to determine the state of advancement of the proteolysis of the cheeses as a function of their manufacturing and ripening method.

TABLE 4
Means (standard deviations) of the determinations of the nitrogenous
fractions according to manufacturing and ripening methods - NT is the
total nitrogen contained in the cheese sample; NS is the fraction of
nitrogen soluble in water of this sample and represents the large
proteolytic fragments (activity, predominantly enzymatic, and bacterial);
PTA is the fraction of soluble nitrogen which is soluble in phosphotungstic
acid and represents the small fragments from fine proteolysis (bacterial
activity, especially lactic acid bacteria).

| Means according to | NS/NT | PTA/NT | PTA/NS |
|---|---|---|---|
| methods | (%) | (%) | (%) |
| Manufacturing in isolator | 21.36 | 4.48 | 21.17 |
| (n = 8) | (±2.18) | (±0.65) | (±3.90) |
| Manufacturing in cheese | 20.93 | 4.40 | 21.11 |
| dairy (n = 8) | (±2.09) | (±0.47) | (±1.96) |
| Ripening under a reducing | 19.59 | 4.44 | 22.64 |
| atmosphere (n = 8) | (±0.65) | (±0.65) | (±3.29) |
| Ripening with free | 22.70 | 4.44 | 19.64 |
| exchange of air (n = 8) | (±2.00) | (±0.46) | (±1.92) |

It is observed that the manufacturing method has little or no effect on the ratios of the nitrogenous fractions with respect to one another. On the other hand, the ripening method quantitatively and qualitatively influences the state of advancement of the proteolysis. In fact, the NS/NT ratio represents the proportion of total, water-soluble, large and small peptide fragments derived from the enzymatic proteolysis (primary proteolysis) but also derived from the bacterial activity (secondary proteolysis) of the flora of the raw milk and of the leavens. The PTA/NS ratio represents, within this soluble fractions the proportion of small peptides (<600 Da) and the amino acids derived from the secondary proteolysis, i.e. a fine proteolysis. The total proteolysis (NS/NT) is greater in the cheeses ripened under air than in the cheeses ripened under gas (P<5%). Various flora: surface flora, natural flora of the milk and recontamination flora, developed in these cheeses ripened under air. These populations definitely had a proteolytic activity, of the protease type, which increased the proportion of peptides without increasing the proportion of small peptides and amino acids (PTA/NT) due to a peptidase activity. These populations did not therefore promote a secondary proteolysis during the ripening under air. In the cheeses ripened under gas, even though the total proteolysis (NS/NT) is not as great, the secondary proteolysis is proportionally greater (PTA/NS) than in the cheeses ripened under air (P<5%). This effect is significant but depends on the day of manufacture (P<5%). The lactococci, at a level 10 times greater in the cheeses ripened under gas than the cheeses ripened in air (10⁹ cfu/g against 10⁸ cfu/g, respectively), are responsible for a fine and extensive proteolysis. Furthermore, the secondary proteolysis eliminates, in the cheese, the bitter peptides generated by the primary proteolysis. This ability of lactococci appears to be strain-dependent. Now, the cheeses manufactured and ripened under air were found to be more bitter, which is coherent with these results.

### Sensory Results

A jury of 12 trained judges established the sensory profile of each cheese by evaluating a set of sensory descriptors covering the areas of texture, flavors and aromas.

The results of the sensory evaluation profile tests were treated statistically by two methods: analysis of variance and partial least squares (PLS) linear regression. In view of the first sensory profile results, the ripening method appeared to influence, in an obvious manner, the differences between the cheeses relative to the manufacturing method, one giving cheeses with a stronger taste than the other. So as not to lose the information on the manufacturing method, a taste test by pairs of cheeses having had the same ripening was carried out by the 12 judges. The results of the paired taste tests were modeled by means of an analysis of variance, also with weighting for the degrees of difficulty of the response.

The statistical analyses show that the technological factor that has the most effect is the ripening. The absence of interaction between the “manufacturing” and “ripening” factors proves that their effects are additive and that the effects of one are independent of the effects of the other.

The statistical analyses express a very marked effect of the ripening method on the texture, flavor (acid) and taste (taste intensity) descriptors, particularly on the groups of aromas. The cheeses ripened under a reducing atmosphere developed milder, less intense aromas, whereas the cheeses ripened for the same period in the air developed intense and evolved aromas. The observed effects are given in table 5.

TABLE 5
Summary of the results of the tests by profiles, comparing
the PLS regression and the analysis of variance

| | | | |
|---|---|---|---|
| | | Cheeses | Cheeses |
| Cheese dairy | Isolator | ripened | ripened |
| cheeses | cheeses | with air | under gas |

Strong characteristics confirmed by the two tests
(analysis of variance and PLS regression)

| | | | |
|---|---|---|---|
| Adhesiveness | Hard boiled | Taste | Pasty |
| | egg white | intensity | |
| | (elasticity) | | |
| Impression | | Aromatic | Acidity |
| of moisture | | intensity | |
| Bitterness | | Aroma: | Aroma: |
| | | evolved | acidified |
| | | lactic | lactic |
| | | Aroma: | |
| | | roasted | |
| | | grilled | |
| | | Aroma: animal | |

Tendencies demonstrated by one of the two tests
(analysis of variance or PLS regression)

| | | | |
|---|---|---|---|
| Taste | Firmness | Bitterness | Firmness |
| intensity | | | |
| Solubility | | Deformability | Adhesiveness |
| | | Hard boiled | |
| | | egg white | |
| | | (elasticity) | |

The manufacturing method appears to influence more particularly the texture descriptors and the bitter flavor of the cheeses. On the other hand, the manufacturing method does not influence the aroma descriptors. The cheeses manufactured in the cheese dairy, which have a much higher fat content and water content, did not give much more of a fatty impression, but produced a greater impression of moistness in the mouth than the cheeses manufactured in the isolator.

### Results on the Appearance of the Cheeses

During the preparation of the samples for the sensory evaluation, the outside and inside appearance of the cheeses was noted. The ripening method appears also to have the greatest influence on the appearance of the cheeses. In fact, the cheeses ripened under a reducing atmosphere had a perfectly normal surface having the same appearance as the cheeses at demolding. The latter had a greater proportion of holes on average than the cheeses ripened with a free exchange of air. They were thicker and less sunken, with a firmer cheese consistency. A proportion of between 70 and 100% of the surface area of the cheeses ripened with a free exchange of air was covered with a “sticky” orangey-yellow flora. These cheeses had the appearance of cheeses that were more advanced in terms of their ripening (“well-done”, or even “overdone” cheeses) with a more tender cheese consistency, slightly sunken into themselves.

### EXAMPLE 2

### Comparison of Cheeses Ripened Under Three Different Atmospheres (Air, Nitrogen, and Nitrogen/Hydrogen)

The following protocol was carried out: 3 uncooked pressed cheeses of 1 kg were manufactured from milk derived from the same milking. The first cheese was then ripened under air, the second under nitrogen and the third under nitrogen/hydrogen (96/4). This protocol was repeated three times.

The leaven used is a commercial mesophilic leaven consisting of a mixture of strains of Lactococcus lactis subsp. lactis and of Lactococcus lactis subsp. cremoris. It is the leaven sold under the name MA 011 (traditional acidifying mesophils, Danisco). For the needs of packaging in bags during ripening, this leaven is not a gas-producing leaven. The leaven was inoculated into the tank in freeze-dried form at the dose of 0.77 U of freeze-dried leaven/100 l of milk, or 0.4-0.5% (V/V) of leaven equivalent with respect to milk. The rennet (700 mg/l of active chymosin, Danisco) was used at the dose of 0.27 ml/kg of milk.

For the ripening, all the cheeses were enclosed in identical glove bags so as to ensure the same moisture levels for the ripening. These bags were heat-sealed. Their conditioning in a ripening atmosphere was carried out by means of a leaktight circuit consisting of one valve per ripening bag for allowing gas to enter or to exit. All the bags (even the bags with air) were emptied and reconditioned every week so as to compensate for any possible permeability of the material of the bags and thus to prevent a modification of the ripening atmosphere. All the cheeses were thus ripened in ripening cellars at 12-13° C. with a relative humidity of greater than 91%.

During bagging, a jar of approximately 100 ml of “morge” [cheese smear] and a brush were introduced with each cheese. The “morge” [cheese smear] is an aqueous solution saturated with salt, containing a halotolerant flora consisting of bacteria and yeasts. The yeasts belong to the Candida, Kluyveromyces, Debaryomyces and Rhodotorula genera. The bacterial flora contain coryneforms (B. linens) and Micrococcaceae (Piton, 1990). The 9 jars come from the same container of “morge” [cheese smear]. The surface flora is introduced onto the cheese by brushing it with the brush twice a week for the first 3 weeks, and then just once every subsequent week.

### Microbiological Analyses

The analysis of variance shows that the amount of heterofermentative mesophilic lactobacilli at the end of ripening was influenced by the ripening method (see table 6, level of test P=7%). These bacteria therefore appear to be favored by a non-reducing atmosphere (air or nitrogen), irrespective of the oxygen content of the ripening atmosphere. The “hydrogen” ripening method would therefore have a tendency to affect the development of this population during ripening.

TABLE 6
Log 10 of means (CFU/g) in the cheeses at the end of ripening.

| Levels of ripening | Air | N₂ | N₂/H₂ |
|---|---|---|---|
| Heterofermentative | 4.0 | 3.7 | 2.0 |
| mesophilic | | | |
| lactobacilli | | | |

### Physicochemical Analyses

The total solids at the end of ripening was also influenced by the ripening method (see table 7). The cheeses ripened under air exuded more water than the cheeses ripened under nitrogen and even more than the cheeses ripened under nitrogen-hydrogen, which have the highest water content at the end of ripening. The packaging bags cannot be responsible for these differences in exudation since all the cheeses were ripened in the same bags and conditioned under gas at the same time at the end of each week with strictly the same protocol. Only the metabolism (presence or absence of ammonia release, degree of proteolysis, etc.) could have influenced the proportion of total solids relative to water in the cheeses during ripening by modifying the state of the water in the cheese.

TABLE 7
% means of the total solids of the cheeses at the end of ripening.

| Levels of ripening | Air | N₂ | N₂/H₂ |
|---|---|---|---|
| Total solids (%) | 54.06 | 52.99 | 51.56 |

### Volatile Compound Analysis

The volatile compounds (other than the volatile fatty acids) were quantified by chromatography coupled to mass spectrometry. The volatile fatty acids were also quantified by chromatography, using standard solutions.

FIG. 1 shows that the volatile fatty acid content of the cheeses ripened under air was lower than that of the cheeses ripened under nitrogen, which itself has a tendency to be lower than that of the cheeses ripened under nitrogen/hydrogen.

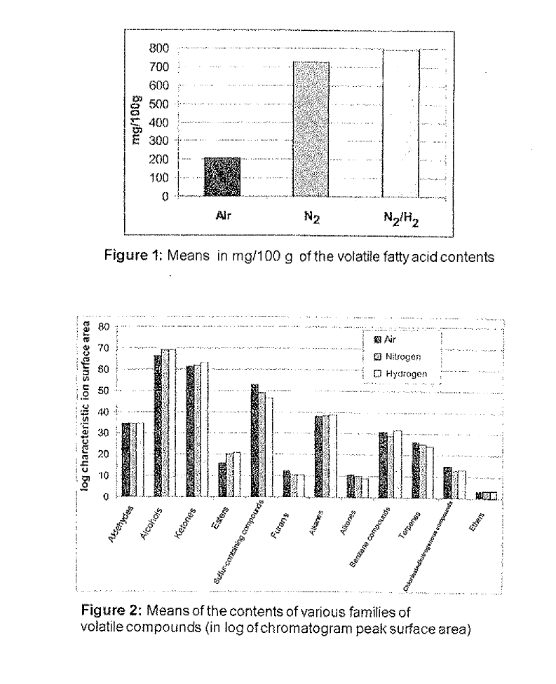

Similarly, FIG. 2 shows, for example, that the more reducing the ripening atmosphere is, the more the cheeses have a tendency to produce ketones. Conversely, the less reducing the ripening atmosphere is, the greater the content of sulfur-containing compounds, alkenes or terpenes in the cheeses.

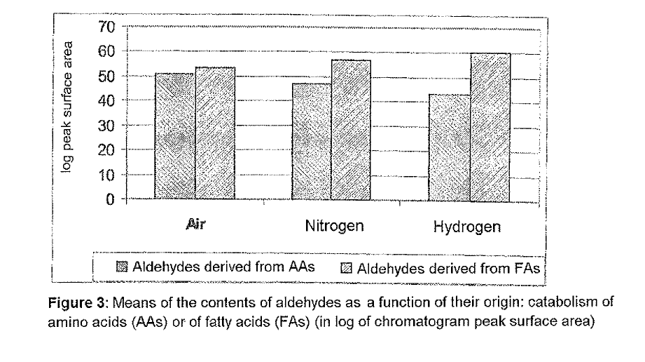

FIG. 3 shows, for its part, that, depending on the ripening atmosphere, the origin of the aldehydes is variable. The more reducing the atmosphere is, the more the aldehydes are predominantly derived from fatty acid catabolism. The more oxidizing the atmosphere is, the more the aldehydes are derived from amino acid catabolism.

### Sensory Analysis

A jury of 11 trained judges tasted and marked the 9 cheeses on the day they came out of ripening, by manufacturing series, i.e. 3 cheeses tasted in 3 sensory evaluation sessions. The order of presentation of the cheeses was determined according to the tables of Macfie et al. The objective of the profile tests was to differentiate and characterize the 3 ripening modes.

The cheeses derived from the ripenings under nitrogen and under nitrogen/hydrogen were also compared in pairs in order to analyze what influence the presence of hydrogen had in the ripening atmosphere. The results of the sensory evaluation profile tests were treated statistically by two methods: analysis of variance, and partial least squares (PLS) linear regression.

These statistical analyses showed that, from a sensory point of view, the cheeses ripened under the various atmospheres were significantly different.

The flavor descriptors were greatly influenced by the ripening method. The cheeses ripened under air are very clearly bitter and not sweet, whereas the cheeses ripened under hydrogen have a tendency to be more acidic and sweeter.

Moreover, the cheeses ripened under nitrogen developed rather fewer aromas than the other cheeses, and the cheeses ripened under air have a bitterness which has a tendency to mask the aromatic diversity. However, certain aromas were marked very differently according to the ripening method, in particular the aromas of the “lactic” family. The cheeses ripened under air are clearly principally marked “evolved lactic” (rind taste), with a perfect consensus from the judges. The same is true of the cheeses ripened under hydrogen. The cheeses ripened under nitrogen are clearly marked “heated lactic”. The cheeses ripened under air are also marked “strong roasted”.

The aim of the paired analysis was to differentiate between the cheeses ripened under hydrogen and the cheeses ripened under nitrogen, since, at the end of the individual tastings of the cheeses, the cheeses of these two ripenings were found to be the closest. Table 8 summarizes the results of the analysis of variance on these data, giving only the descriptors significantly different for these two ripenings.

TABLE 8
Results of the analysis of variance carried out on the data
from the paired tastings comparing a cheese ripened under
nitrogen and a cheese ripened under nitrogen/hydrogen

| | | The N₂ method | The N₂/H₂ method |
|---|---|---|---|
| | | is more | is more |
| | | “[descriptor]” | “[descriptor]” |
| | | than the N₂/H₂ | than the N₂ |
| | | method | method |
| Descriptors | Deformability | | * |
| | Firmness | *** | |
| | Hard boiled | * | |
| | egg white | | |
| | Solubility | | * |
| | Taste | * | |
| | intensity | | |
| | Acidified | | * |
| | lactic | | |
| | Heated lactic | ** | |
| | Sulfury garlic | * | |
| | smell | | |

* significant at P < 5%;
** significant at P < 1%;
*** significant at P < 0.1%.

Table 8 confirms the differences in texture between these two ripening methods. The cheeses ripened under nitrogen are more “firm” and more “hard boiled egg white” and therefore less “deformable” than the cheeses ripened under hydrogen. The cheeses ripened under hydrogen are definitively more soluble than the cheeses ripened under nitrogen. This paired evaluation also confirms the differences in taste and in aromas. The cheeses ripened under nitrogen have a more intense taste. They are more “heated lactic” and “sulfury garlic smell”. Finally, the cheeses ripened under hydrogen are marked “acidified lactic”.

### Appearance of the Cheeses

The ripening method also appears to have an influence on the appearance of the cheeses.

In fact, the cheeses ripened under air had an orangey surface covered with a flora distributed uniformly over the entire cheese. The latter had holes that were on average larger than the cheeses ripened under special gases. The surface flora appears to have developed more on the cheeses ripened under hydrogen than on those ripened under nitrogen.

1-12. (canceled)

13: A method for manufacturing a ripened cheese having enhanced organoleptic properties, which consists, during one of the steps of the manufacturing method, in inoculating a dairy mixture with one or more lactic bacterial strains, and in carrying out a step of ripening the manufactured cheese, and which is characterized in that one or each of the following steps is carried out:
a) prior to the inoculating step, the dairy mixture is processed with a processing gas comprising a neutral gas or a reducing gas or a mixture of such gases so as to obtain a desired redox potential Eh value for the dairy mixture which is less than the value obtained when the dairy mixture is in equilibrium with the air;
b) all or part of the ripening step is carried out under a reducing ripening atmosphere.

14: The method for manufacturing a ripened cheese of claim 13, wherein said reducing ripening atmosphere is obtained using a reducing gas, or using a mixture of a neutral gas and a reducing gas.

15: The method for manufacturing a ripened cheese of claim 13, wherein, for the purposes of carrying out all or part of the ripening step under a reducing atmosphere, the cheese is placed, after its manufacture, in a chamber or else a packaging which is leaktight and which contains such an atmosphere.

16: The method for manufacturing a ripened cheese of claim 13, wherein said desired redox potential value is less than about +250 mV.

17: The method for manufacturing a ripened cheese of claim 16, wherein said desired redox potential value is at least about 100 mV less than the value obtained when the dairy mixture is in equilibrium with the air.

18: The method for manufacturing a ripened cheese of claim 16, wherein said desired redox potential value is negative.

19: The method for manufacturing a ripened cheese of claim 13, wherein the inoculation of the dairy mixture is carried out indirectly due to the fact that one or more successive precultures are carried out beforehand in order to constitute the inoculum which will be used to inoculate the dairy mixture, and wherein the preculture is also processed by processing its growth medium with a pre-processing gas which makes it possible to obtain a redox potential value which is less than the value that would be obtained in the absence of processing.

20: The method for manufacturing a ripened cheese of claim 13, wherein one or more of said processing or pre-processing gases or ripening atmosphere is hydrogen or a mixture of gases containing hydrogen.

21: The method for manufacturing a ripened cheese of claim 13, wherein one or more of said processing or pre-processing gases or ripening atmosphere comprises hydrogen and/or nitrogen and a supplementary gas which is acceptable from the point of view of said cheese under consideration.

22: The method for manufacturing a ripened cheese of claim 21, wherein the supplementary gas is chosen from inert gases, in particular argon and helium, and from oxygen, carbon dioxide and nitrous oxide, and mixtures thereof in any proportions, preferably from carbon dioxide and oxygen, and mixtures thereof.

23: The method for manufacturing a ripened cheese of claim 13, wherein a part of the ripening is carried out conventionally under air or under another atmosphere, and a part of the ripening is carried out under said reducing ripening atmosphere.

24: The method for manufacturing a ripened cheese of claim 13, wherein the cheese is subsequently conserved under a controlled atmosphere until its best before date (“BBD”) or its use by date (“UBD”).
